(19) United States
(12) Patent Application Publication
(10) Pub. No.: US 2026/0056974 A1
(43) Pub. Date: Feb. 26, 2026

(54) Dual Engine Technique Based-On Open-Source RDBMS

(71) Applicant: Datagrit Corp., Suwon-si (KR)

(72) Inventors: Owook JO, Gyeonggi-do (KR); Jiyong SONG, Yongin-si (KR)

(73) Assignee: Datagrit Corp., Suwon-si (KR)

(21) Appl. No.: 19/177,010

(22) Filed: Apr. 11, 2025

(30) Foreign Application Priority Data
Aug. 21, 2024 (KR) 10-2024-0111833

(51) Int. Cl. G06F 16/28; G06F 16/22; G06F 16/2455

(52) U.S. Cl. CPC G06F 16/285; G06F 16/2237; G06F 16/2456

(57) ABSTRACT

According to an embodiment of the present disclosure, a method for processing a query performed by a computing device operable based on a Database Management System (DBMS) is disclosed. The method may include: receiving a query requesting an execution result in the DBMS; determining a type of the query as a transactional query or an analytic query based on predetermined criteria for classifying the query; and generating an execution result corresponding to the query by adaptively determining an engine for processing the query among a plurality of different engines or by processing the query in different ways, according to the determined type of the query.

### CROSS-REFERENCE TO RELATED APPLICATIONS

This application claims priority to and the benefit of Korean Patent Application No. 10-2024-0111833 filed in the Korean Intellectual Property Office on Aug. 21, 2024, the entire contents of which are incorporated herein by reference.

### TECHNICAL FIELD

The present disclosure relates to a database management system (DBMS), and more particularly, to a technique for processing a query performed by a computing device operable based on the DBMS.

### BACKGROUND ART

A DBMS as a database management system represents a software system for managing and manipulating a database. The DBMS can provide a function to efficiently store, modify, retrieve, and manage data. In the DBMS as a query prepared in an SQL statement is received, the query is interpreted, optimized, and executed, so a result corresponding to the query can be returned. The DBMS can include an RDBMS that structuralizes and manages data.

The RDBMS as a relational database management system represents a software system for structuralizing data, and managing and manipulating a database. The RDBMS can structuralize, and store and manage data according to a relational model.

An RDBMS technology is developed to meet a speed of data processing, a possibility of a real-time analysis, and a demand for mass data processing.

### SUMMARY OF THE INVENTION

A technique according to one embodiment of the present disclosure has been made in an effort to increase a processing and/or execution speed, and efficiency of a query in a DBMS system. A technique according to one embodiment of the present disclosure has been made in an effort to efficiently use a computing resource in processing and/or executing the query in the DBMS system.

A technique according to one embodiment of the present disclosure has been made in an effort to increase the processing and/or execution speed, and the efficiency of the query in an RDBMS system. A technique according to one embodiment of the present disclosure has been made in an effort to efficiently use the computing resource in processing and/or executing the query in the RDBMS system.

According to an embodiment of the present disclosure, a method for processing a query performed by a computing device operable based on a Database Management System (DBMS) is disclosed. The method may include: receiving a query requesting an execution result in the DBMS; determining a type of the query as a transactional query or an analytic query based on predetermined criteria for classifying the query; and generating an execution result corresponding to the query by adaptively determining an engine for processing the query among a plurality of different engines or by processing the query in different ways, according to the determined type of the query.

In one embodiment, the predetermined criteria may include criteria related to the number of tuples to be processed to generate a result of the query, the transactional query may be a query where the number of tuples of the query is less than a predetermined first threshold value, and the analytic query may be a query where the number of tuples of the query is equal to or greater than the predetermined first threshold value.

In one embodiment, the predetermined criteria may include criteria related to a type of operator of the query, the transactional query may include at least one of a query including Database Manipulation Language (DML), a query including Database Definition Language (DDL), a query searching for specific data, or a query where an index exists when searching for data, and the analytic query may include a query containing at least one of an order by operator, a group by operator, a join operator, an aggregation function, or a window function.

In one embodiment, the predetermined criteria may include criteria related to a processing method for transactions of the query, the transactional query may be a query used in Online Transaction Processing (OLTP), and the analytic query may be a query used in Online Analytical Processing (OLAP).

In one embodiment, generating the execution result corresponding to the query may include: generating a first execution result corresponding to the query by processing the query using a first engine for processing the analytic query when the type of the query is determined to be the analytic query; and generating a second execution result corresponding to the query by processing the query using a second engine for processing the transactional query when the type of the query is determined to be the transactional query.

In one embodiment, the first engine may include a Query Execution Engine based on Online Analytical Processing (OLAP), and the second engine may include a Query Execution Engine based on Online Transaction Processing (OLTP).

In one embodiment, generating the first execution result corresponding to the query may include: parsing the received query; performing logical optimization on the parsed query to determine an order for processing requests included in the parsed query; performing physical optimization on the logically optimized query to determine an operation method necessary for processing the requests according to the determined order; building a plurality of pipelines and dependencies between the plurality of pipelines based on the physically optimized query—where a pipeline is a set of one or more operators and represents a processing unit of the query—; building at least one schedule for processing the query based on the dependencies between the plurality of pipelines; building a plurality of tasks based on the at least one schedule; adding the plurality of tasks to a task queue; processing the plurality of tasks by allocating the plurality of tasks added to the task queue to a plurality of worker threads included in a worker thread pool; and generating the first execution result including information on the result of processing the plurality of tasks.

In one embodiment, building the plurality of pipelines and the dependencies between the plurality of pipelines may include: building the plurality of pipelines based on an operator corresponding to a pipeline breaker, wherein the pipeline breaker is an operator that is the start or end of each pipeline, including at least one of a sort operator, a group by operator, a join operator, an aggregation function, or a window function.

In one embodiment, building the plurality of pipelines and the dependencies between the plurality of pipelines may include: determining a type of each of a plurality of operators included in each of the plurality of pipelines as one of an Origin role type, an On-The-Fly role type, or a Destination role type, wherein the Origin role type is a role of a start operator of a pipeline, generating, loading, or pre-processing a chunk, the On-The-Fly role type receives one chunk and processes it in memory, and the Destination role type processes the chunk to generate an output chunk.

In one embodiment, processing the plurality of tasks may include: allocating a first-first task to a first worker thread to process the first-first task among a plurality of first tasks corresponding to a first schedule in the first worker thread; and processing the first-first task using the first worker thread.

In one embodiment, processing the first-first task using the first worker thread may include: processing the first-first task by executing at least one operator included in a first pipeline corresponding to the first-first task using the first worker thread; determining whether a second schedule different from the first schedule exists if a type of the processed first-first task is a share task type shared with other worker threads, and the number of completed share tasks corresponds to a predetermined number of total share tasks; building a plurality of second tasks corresponding to the second schedule using the first worker thread if it is determined that the second schedule exists; and adding the plurality of second tasks to the task queue.

In one embodiment, processing the first-first task by executing at least one operator included in a first pipeline corresponding to the first-first task using the first worker thread may include: assigning a first-first operator, which is an origin operator among at least one first operator included in the first pipeline, as a current operator being processed if a type of the first-first task is an isolate task not shared with other worker threads; confirming a type of the first-first operator if a role type of the first-first operator is an origin role type; attempting to acquire a tuple from a data file of the DBMS if the type of the first-first operator is a scan operator; converting the acquired tuple into vectors for each column and selecting vectors necessary for processing the query to generate a first chunk if the acquisition of the tuple is successful; increasing the number of completed isolate tasks by a predetermined number if the acquisition of the tuple fails; and scheduling a share task if the number of completed isolate tasks corresponds to a predetermined number of total isolate tasks.

In one embodiment, the method may further include: attempting to acquire a second chunk if the type of the first-first operator is not a scan operator after confirming the type of the first-first operator; executing the first-first operator if the acquisition of the second chunk is successful; and increasing the number of completed isolate tasks by the predetermined number if the acquisition of the second chunk fails.

In one embodiment, processing the first-first task by executing at least one operator included in a first pipeline corresponding to the first-first task using the first worker thread may include: assigning a first-second operator, which is a destination operator among at least one first operator included in the first pipeline, as a current operator being processed if a type of the first-first task is a shared task; attempting to acquire a third chunk generated in an isolate task; executing the first-second operator if the acquisition of the third chunk is successful; increasing the number of completed share tasks by a predetermined number if the acquisition of the third chunk fails.

In one embodiment, a computer program stored on a computer-readable storage medium is disclosed. The computer program causes a processor of a computing device operable based on a Database Management System (DBMS) to perform a method for processing a query, the method including: receiving a query requesting an execution result in the DBMS; determining a type of the query as a transactional query or an analytic query based on predetermined criteria; and generating an execution result corresponding to the query by adaptively determining an engine for processing the query among a plurality of different engines or by processing the query in different ways, according to the determined type of the query.

In one embodiment, a computing device operable based on a Database Management System (DBMS) is disclosed. The computing device includes: a processor; a memory; and a network unit, wherein the processor is configured to: receive a query requesting an execution result in the DBMS; determine a type of the query as a transactional query or an analytic query based on predetermined criteria; and generate an execution result corresponding to the query by adaptively determining an engine for processing the query among a plurality of different engines or by processing the query in different ways, according to the determined type of the query.

According to a technique according to one embodiment of the present disclosure, a processing and/or execution speed, and efficiency of a query can be increased in a DBMS system. According to a technique according to one embodiment of the present disclosure, a computing resource can be efficiently used in processing and/or executing the query in the DBMS system.

According to a technique according to one embodiment of the present disclosure, the processing and/or execution speed, and the efficiency of the query can be increased in an RDBMS system. According to a technique according to one embodiment of the present disclosure, the computing resource can be efficiently used in processing and/or executing the query in the RDBMS system.

### BRIEF DESCRIPTION OF THE DRAWINGS

FIG. 1 exemplarily illustrates a block diagram of a computing device according to an exemplary embodiment of the present disclosure.

FIG. 2 illustrates an exemplary flowchart for generating an execution result of a query according to an exemplary embodiment of the present disclosure.

FIG. 3 exemplarily illustrates a flowchart for processing a task using an engine according to an exemplary embodiment of the present disclosure.

FIG. 4 exemplarily illustrates a block diagram of a DBMS according to an exemplary embodiment of the present disclosure.

FIG. 5 exemplarily illustrates a pipeline corresponding to an input query according to an exemplary embodiment of the present disclosure.

FIG. 6 exemplarily illustrates a scan according to an exemplary embodiment of the present disclosure.

FIG. 7 exemplarily illustrates a process for processing a plurality of tasks according to an exemplary embodiment of the present disclosure.

FIG. 8 exemplarily illustrates a process for processing a plurality of tasks according to another exemplary embodiment of the present disclosure.

FIG. 9 exemplarily illustrates a process of executing an operator included in the pipeline according to an exemplary embodiment of the present disclosure.

FIG. 10 exemplarily illustrates a process of executing an operator included in the pipeline according to another exemplary embodiment of the present disclosure.

FIG. 11 illustrates a simple and general schematic view of an exemplary computing environment in which the embodiments of the present disclosure may be implemented.

### DETAILED DESCRIPTION

Various embodiments will now be described with reference to drawings. In the present specification, various descriptions are presented to provide appreciation of the present disclosure. However, it is apparent that the embodiments can be executed without the specific description.

“Component”, “module”, “system”, and the like which are terms used in the specification refer to a computer-related entity, hardware, firmware, software, and a combination of the software and the hardware, or execution of the software. For example, the component may be a processing process executed on a processor, the processor, an object, an execution thread, a program, and/or a computer, but is not limited thereto. For example, both an application executed in a computing device and the computing device may be the components. One or more components may reside within the processor and/or a thread of execution. One component may be localized in one computer. One component may be distributed between two or more computers. Further, the components may be executed by various computer-readable media having various data structures, which are stored therein. The components may perform communication through local and/or remote processing according to a signal (for example, data transmitted from another system through a network such as the Internet through data and/or a signal from one component that interacts with other components in a local system and a distribution system) having one or more data packets, for example.

Moreover, the term “or” is intended to mean not exclusive “or” but inclusive “or”. That is, when not separately specified or not clear in terms of a context, a sentence “X uses A or B” is intended to mean one of the natural inclusive replacements. That is, the sentence “X uses A or B” may be applied to any of the case where X uses A, the case where X uses B, or the case where X uses both A and B. Further, it should be understood that the term “and/or” used in this specification designates and includes all available combinations of one or more items among enumerated related items.

Further, it should be appreciated that the term “comprise” and/or “comprising” means presence of corresponding features and/or components. However, it should be appreciated that the term “comprises” and/or “comprising” means that presence or addition of one or more other features, components, and/or a group thereof is not excluded. Further, when not separately specified or it is not clear in terms of the context that a singular form is indicated, it should be construed that the singular form generally means “one or more” in this specification and the claims.

In addition, the term “at least one of A or B” should be interpreted to mean “a case including only A”, “a case including only B”, and “a case in which A and B are combined”.

Those skilled in the art need to recognize that various illustrative logical blocks, configurations, modules, circuits, means, logic, and algorithm steps described in connection with the embodiments disclosed herein may be additionally implemented as electronic hardware, computer software, or combinations of both sides.

The description of the presented embodiments is provided so that those skilled in the art of the present disclosure use or implement the present disclosure. Various modifications to the embodiments will be apparent to those skilled in the art. Generic principles defined herein may be applied to other embodiments without departing from the scope of the present disclosure. Therefore, the present disclosure is not limited to the embodiments presented herein. The present disclosure should be analyzed within the widest range which is coherent with the principles and new features presented herein.

Terms expressed as N-th such as first, second, or third in the present disclosure are used to distinguish at least one entity. For example, entities expressed as first and second may be the same as or different from each other.

Terms expressed as N-M such as first-first or first-second in the present disclosure are used to distinguish M entities included in a higher group N. For example, entities expressed as first-first and first-second may be the same as or different from each other.

In addition, the term “˜etc.”, such as “A, B, etc.” should be interpreted to mean “a case including only A”, “a case including only B”, and “a case in which A and B are combined”.

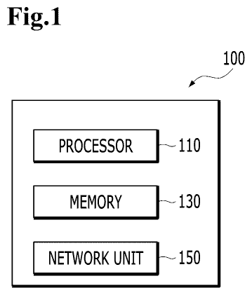

FIG. 1 exemplarily illustrates a block diagram of a computing device according to one embodiment of the present disclosure.

A configuration of the computing device 100 illustrated in FIG. 1 is only an example shown through simplification. In one embodiment of the present disclosure, the computing device 100 may include other components for performing the computing environment of the computing device 100, and only some of the disclosed components may constitute the computing device 100. As an example, when the computing device 100 includes a user terminal, an output unit (not illustrated) and an input unit (not illustrated) may be included in a scope of the computing device 100.

In one embodiment, the computing device 100 may mean an entity which is enabled to operate based on a database management system (DBMS), and represent a database server or represent a client server. In another exemplary embodiment, the computing device 100 may mean an entity which is enabled to operate based on a relational database management system (RDBMS).

The computing device 100 in the present disclosure may be used as a meaning that encompasses any type of server and any type of terminal.

The computing device 100 in the present disclosure may be intended to include a client and/or a database server. The computing device 100 may mean a node(s) in a database system having a mechanism for communication through the network. For example, the computing device 100 may include a predetermined electronic device having connectivity with a personal computer (PC), a laptop computer, a workstation, a terminal, and/or the network. Further, the computing device 100 may include a predetermined server implemented by at least one of agent, application programming interface (API), and plug-in.

For example, the computing device 100 in FIG. 1 may be related to a user (e.g., database administration (DBA)) using the database server. In such an example, the computing device 100 may issue a query statement to the database server. For example, the computing device 100 in FIG. 1 may represent the database server.

In the present disclosure, the computing device 100 may mean any type of component constituting a system for implementing exemplary embodiments of the present disclosure.

In one embodiment, the computing device 100 may include a processor 110 for executing a DBMS and/or an RDBMS, a memory 130 for storing and managing data related to the DBMS and/or the RDBMS, and a network unit 150 for performing a communication related to the DBMS and/or the RDBMS. In another exemplary embodiment, the computing device 100 may include a permanent storage medium for storing and managing data related to the DBMS and/or the RDBMS According to an implementation aspect, the memory 130 may be used to encompass the permanent storage medium.

In one embodiment, the processor 110 may perform an overall operation of the computing device 100. For example, the processor 110 processes data, information, or? signals, and the like input or output through the components included in the computing device 100 or drives the application program stored in a storage unit to provide information or a function appropriate for the user.

The processor 110 may be constituted by at least one core. The processor 110 may include devices for data analysis and/or processing, which include a central processing unit (CPU), a general purpose graphics processing unit (GPGPU), a tensor processing unit (TPU), and the like of the computing device 100.

The processor 110 may read a computer program stored in the memory 130 to generate an execution plan corresponding to a query and generate an execution result corresponding to the query according to one embodiment of the present disclosure.

According to an embodiment of the present disclosure, the memory 130 may store any type of information generated or determined by the processor 110 or any type of information received by the computing device 100. According to one embodiment of the present disclosure, the memory 130 may be a storage medium that stores computer software which allows the processor 110 to perform the operations according to the exemplary embodiments of the present disclosure. Therefore, the memory 130 may mean computer-readable media for storing software codes required for performing the embodiments of the present disclosure, data which become execution targets of the codes, and execution results of the codes.

According to an embodiment of the present disclosure, the memory 130 may mean any type of storage medium, and include, for example, at least one type of storage medium of a flash memory type storage medium, a hard disk type storage medium, a multimedia card micro type storage medium, a card type memory (for example, an SD or an XD memory, or the like), a random access memory (RAM), a static random access memory (SRAM), a read-only memory (ROM), an electrically erasable programmable read-only memory (EEPROM), a programmable read-only memory (PROM), a magnetic memory, a magnetic disk, and an optical disk. The computing device 100 may operate in connection with a web storage performing a storing function of the memory 130 on the Internet. The description of the memory is just an example and the memory 130 used in the present disclosure is not limited to the examples.

In the present disclosure, the network unit 150 may be configured regardless of communication modes such as wired and wireless modes and constituted by various communication networks including a personal area network (PAN), a wide area network (WAN), and the like. Further, the network unit 150 may operate based on known World Wide Web (WWW) and may adopt a wireless transmission technology used for short-distance communication, such as infrared data association (IrDA) or Bluetooth. For example, the network unit may include a database link (dblink), and as a result, a plurality of computing devices communicates with each other through the database link to fetch data from another computing device 100. The techniques described in this specification may also be used in other networks in addition to the aforementioned networks.

The computing device 100 in the present disclosure may include any type of user terminal and/or any type of server. Therefore, the embodiments of the present disclosure may be performed by the server and/or the user terminal.

In one embodiment, the user terminal may include any type of terminal which is capable of interacting with the server or another computing device. The user terminal may include, for example, a mobile phone, a smart phone, a laptop computer, personal digital assistants (PDA), a slate PC, a tablet PC, and an ultrabook. In one embodiment, the user terminal may mean a device including a camera, which is installed in the vehicle.

In one embodiment, the server may include, for example, any type of computing system or computing device such as a microprocessor, a mainframe computer, a digital processor, a portable device, and a device controller.

In one embodiment, the server may include a storage unit (not illustrated) for storing data and/or information used in the present disclosure. The storage unit may be included in the server, or may be present under the management of the server. As another example, the storage unit may also be present outside the server, and implemented in a form which is capable of communicating with the server. In this case, the storage unit may be managed and controlled by another external server different from the server. As another example, the storage unit may also be present outside the server, and implemented in a form which is capable of communicating with the server. In this case, the storage unit may be managed and controlled by another external server different from the server.

In the present disclosure the DBMS or the RDBMS may be operated by the processor 110 on the memory 130.

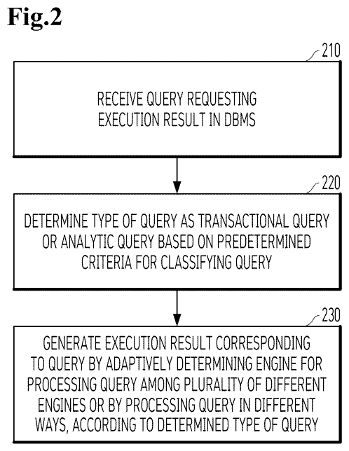

FIG. 2 illustrates an exemplary flowchart for generating an execution result of a query according to one embodiment of the present disclosure. Steps illustrated in FIG. 2 are exemplary steps. Therefore, it will also be apparent to those skilled in the art that some of the steps of FIG. 2 may be omitted or there may be additional steps within a range without departing from the spirit scope of the present disclosure. Further, specific contents regarding the components (e.g., the computing apparatus 100, etc.) disclosed in FIG. 2 may be replaced with the contents described through FIG. 1 above. In one embodiment, the examples illustrated in FIG. 2 may be performed by the computing device 100 (for example, the processor 110 of the computing device 100).

In one embodiment, the computing device 100 may process a query by using a dual engine technique. For example, the computing device 100 may process the query by using a dual engine technique based on an open-source RDBMS. The RDBMS as a relational database management system may mean a software system for structuralizing data, and managing and manipulating a database. The RDBMS can structuralize, and store and manage data according to a relational model.

In one embodiment, the dual engine technique may be a technique for determining an engine for processing the query based on a type of query. In one embodiment, the dual engine technique may use a Query Execution Engine based on Online Analytical Processing (OLAP) and a query execution engine based on Online Transaction Processing (OLTP). For example, the dual engine technique may process the query by using the Query Execution Engine based on Online Analytical Processing (OLAP) when the type of query is an analytical query. As another example, the dual engine technique may process the query by using the Query Execution Engine based on Online Transaction Processing (OLTP) when the type of query is a transactional query.

Hereinafter, a specific method of processing the query by using the dual engine technique will be described below.

In one embodiment, the computing device 100 may receive a query requesting an execution result in the DBMS (210).

For example, the query may mean a request statement prepared with a Structured query language (SQL) statement. For example, the query may be prepared by a user. Here, “user” may also be used exchangeably with “client” or “DBA”. Further, here, “query” and “SQL statement” may also be used exchangeably with each other. For example, the SQL statement for generating the query may include a Data Definition Language (DDL) and a Data Manipulation Language (DML).

In one embodiment, the computing device 100 may perform any database operation corresponding to the query in response to reception to the query. For example, the computing device 100 may perform a database operation corresponding to a total query and/or a sub query. Further, the computing device 100 may also perform any database operation generated in generating output information for the query. Additionally, the computing device 100 may also perform any database operation performed according to a determined storing scheme.

In one embodiment, the computing device 100 may determine the type of query as a transactional query or an analytical query based on predetermined criteria for classifying the query (220).

In one embodiment, the predetermined criteria may include criteria related to the number of tuples of the query. Therefore, the computing device 100 may determine the type of query as the transactional query or the analytical query according to the number of tuples of the query. For example, the transaction query may be a query where the number of tuples of the query is less than a predetermined first threshold value (e.g. 5, etc.). The analytical query may be a query where the number of tuples of the query is equal to or greater than the predetermined first threshold value.

In one embodiment, the predetermined criteria may include criteria related to a type of operator of the query. Therefore, the computing device 100 may determine the type of query as the transactional query or the analytical query according to the type of operator of the query. For example, the transactional query may include at least one of a query including a Database Manipulation Language (DML), a query including a Database Definition Language (DDL), a query searching for specific data, or a query where an index exists when searching for data. The analytical query may include at least one of an order by operator, a group by operator, a join operator, an aggregation function, and/or a window function.

In one embodiment, the join operator may be used for determining data between tables in a database. For example, the join operator may be used for combining a specific row and/or column between the tables in the database. In one embodiment, the analytical query may also include a join operator where the index related to the query does not exist.

In one embodiment, the sort operator may be used for sorting result sets in the database. For example, the sort operator may be used for adjusting an order of the searched data or for sorting queried results according to desired criteria.

In one embodiment, a grouping operator may be used for grouping results in the database. For example, the grouping operator may group data according to a value of a specific column.

In one embodiment, the aggregation function may be used for performing a specific operation in the database. For example, the aggregation function may include a COUNT function of calculating the number of rows in a specific column, a SUM function of calculating a sum total for the specific column, an AVG function of calculating an average value for the specific column, etc. In one embodiment, the analytical query may also include an aggregation function where a selectivity is equal to or greater than a predetermined second threshold value (e.g., 80%, etc.). In one embodiment, the selectivity may mean a ratio of data satisfying a specific condition. For example, in a WHERE phrase or a JOIN condition, the selectivity may mean a ratio of a row satisfying a condition.

In one embodiment, the window function may be used for partitioning data into partitions, or sorting data in the database, or performing a specific calculation for a window including a range before or after a current row to add a calculated value to each row. For example, the window function may include a RANK function of ranking rows in the window, a MAX function of calculating a maximum value for a specific column in the window, a FIRST_VALUE function of calculating a value of a first value upon sorting under a specific condition in the window, a CUME_DIST function of calculating a cumulative distribution for a current row in the window, etc.

In one embodiment, the predetermined criteria may include criteria related to a processing scheme for a transaction of the query. The transaction of the query may mean one or more tasks to be executed at once in the DBMS. Therefore, the computing device 100 may determine the type of query as the transactional query or the analytical query according to the processing scheme for the transaction of the query. For example, the transaction query may be a query used in Online Transaction Processing (OLTP). The analytical query may be a query used in Online Analytical Processing (OLAP).

In one embodiment, the computing device 100 may adaptively determine an engine for processing the query among a plurality of different engines, or processing the query in different ways, according to the determined type of query to generate an execution result corresponding to the query (230).

In the present disclosure, the engine may mean software which serves to store and manage data in the database. The engine may implement an internal operating mechanism of the database, and perform function such as storage, search, update, deletion, etc., of data.

In one embodiment, when the type of query is determined as the analytical query, the query is processed by using a first engine for processing the analytical query to generate a first execution result corresponding to the query.

In one embodiment, the first engine may include a Query Execution Engine based on the Online Analytical Processing (OLAP). In one embodiment, the OLAP may be a management system that may process a large amount of data in the database. The OLAP may use recording and aggregation data of several sources. Therefore, the OLAP may be specialized for processing the analytical query having a larger data size than the transactional query having a relatively small data size.

In one embodiment, when the type of query is determined as the transactional query, the query is processed by using a second engine for processing the transactional query to generate a second execution result corresponding to the query.

In one embodiment, the second engine may include a Query Execution Engine based on the Online transaction Processing (OLTP). In one embodiment, the OLTP may be a management system that may process the transaction in the database. The OLTP may use real-time and transaction data of a single source. Therefore, the OLTP may be specialized for processing the transactional query having a relatively smaller data size than the analytical query having a large data size.

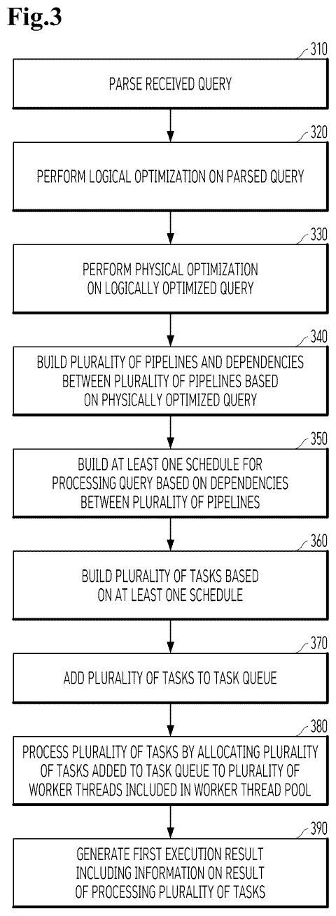

FIG. 3 exemplarily illustrates a flowchart for processing a task using an engine according to one embodiment of the present disclosure. In one embodiment, FIG. 3 may be a flowchart illustrating a process of generating the first execution result corresponding to the query by processing the query determined as the analytical query by using the first engine for processing the analytical query. Steps illustrated in FIG. 3 are exemplary steps. Therefore, it will also be apparent to those skilled in the art that some of the steps of FIG. 3 may be omitted or there may be additional steps within a range without departing from a spirit scope of the present disclosure. Further, specific contents regarding the components (e.g., the computing device 100, etc.) disclosed in FIG. 3 may be replaced with the contents described through FIGS. 1 and 2 above. In one embodiment, the examples illustrated in FIG. 3 may be performed by the computing device 100 (for example, the processor 110 of the computing device 100).

Referring to FIG. 3, the computing device 100 may parse a received query (310).

In one embodiment, the computing device 100 parses the received query to determine a processing scheme and/or a storage scheme for the received query. In one embodiment, the processing scheme may include determining a pipeline for the query, determining an optimization scheme for the query, or determining operators corresponding to pipelines for the query, respectively. In one embodiment, the storage scheme may include an internal storage scheme or an external storage scheme. For example, the internal storage scheme may include a storage scheme using a storage (e.g., a memory, etc.) inside the database, such as a table type output. Further, the external storage scheme may include a storage scheme using a storage (e.g., a permanent storage medium such as a disk) outside the database, such as a file type output.

The computing device 100 may perform logical optimization for the parsed query in order to determine an order for processing a request included in the parsed query (320).

In one embodiment, the logical optimization may be a process of analyzing a logical structure of the query. The logical optimization may mean performing at least one of query analysis, join order determination, index selection, filtering condition optimization, aggregation function optimization, and/or window function optimization. In one embodiment, the query analysis as a process of analyzing an intention of the query by analyzing the query may mean determining a table to be queried by the query, a join condition, a filtering condition, etc. In one embodiment, the join order determination may mean determining an optimal join order when joining several tables. In one embodiment, the index selection may mean determining an index to be used by the query, and selecting an optimal index. The filtering condition optimization may mean applying a condition in an optimal order by analyzing a filtering condition in the WHERE phrase, or improving a performance by reconfiguring the condition if possible. In one embodiment, the aggregation function optimization may mean determining an operating order so that aggregation may be performed by an optimal method in the case of a query including the aggregation function. In one embodiment, the window function optimization may mean determining an operating order so that the window function may be calculated by an optimal method in the case of a query including the window function.

The computing device 100 may perform physical optimization for a logically optimized query in order to determine an operating scheme necessary for processing a request for the determined order (330).

In one embodiment, the physical optimization may be performed after the logical optimization is completed, and may mean maximizing a performance by considering a feature of an actual database system. The physical optimization may include index selection and building, table partitioning, query tuning, etc. In one embodiment, the index selection and building may mean building an actual index or changing an index to be used based on the index selection determined in the logical optimization. The physical optimization selects an optimal index which meets the filtering and join conditions of the query to improve data access speed. In one embodiment, the table partitioning may mean physically partitioning a table in order to enhance a performance of a large-capacity table. In one embodiment, the query tuning may mean optimizing a query execution plan by considering physical environments such as a hardware resource, an operating system, a storage device, etc., of the actual database system.

The computing device 100 may build a plurality of pipelines for processing the query, and a dependency between the plurality of pipelines, based on a physically optimized query (340).

In one embodiment, the pipeline may be a set of one or more operators. The pipeline may represent a processing unit of the query.

In one embodiment, the operator may be a symbol or a keyword that represents a function used for processing or manipulating data in the database. Such an operator may be used for performing various tasks such as filtering, sorting, grouping, or combination of data.

In one embodiment, the computing device 100 may build a plurality of pipelines based on an operator corresponding to a pipeline breaker.

In one embodiment, the pipeline breaker as an operator which is a start or an end of each pipeline may include at least one of a sort operator, a grouping operator, a join operator, an aggregation function, or a window function. Operations of the operators may be operations requiring all tuples. In one embodiment, only when all outputs for the corresponding pipeline are generated, a subsequent pipeline may be performed. As one example, when there is a dependency between a first pipeline and a second pipeline, the second pipeline may be performed only when the first pipeline is ended.

In one embodiment, the computing device 100 may determine types of a plurality of operators included in the plurality of pipelines, respectively as any one of an Origin role type, an On-The-Fly role type, a Destination role type, respectively.

In one embodiment, the Origin role type as a role of a start operator of the pipeline may perform generating, loading, or pre-processing a chunk. For example, the Origin role type may include a scan operator, a sort operator, etc.

In one embodiment, the On-The-Fly role type may receive one chunk and process it in the memory. For example, the On-The-Fly role type may include a filter operator.

In one embodiment, the Destination role type may process the chunk to generate an output chunk. For example, the Destination role type may include the sort operator, the aggregation function, the window function, etc.

In one embodiment, a type of an operator which is duplicated in the plurality of pipelines may be different for each pipeline. For example, when the sort operator is duplicated in the first pipeline and the second pipeline, the sort operator may be the Destination role type in the first pipeline, and the sort operator in the second pipeline may be the Origin role type in the second pipeline.

The computing device 100 may build at least one schedule for processing the query based on the dependency between the plurality of pipelines (350).

In one embodiment, at least one schedule may mean a time order executed according to the dependency between the plurality of pipelines. For example, the computing device 100 may build the schedule so that the first pipeline is first performed, and the second pipeline is then performed when there is the dependency between the first pipeline and the second pipeline.

The computing device 100 may build a plurality of tasks based on at least one schedule (360).

In the present disclosure, the task may mean work of a performing unit processible at once in a worker thread.

The computing device 100 may add the plurality of tasks to a task queue (370).

In the present disclosure, the task queue may mean a queue having control information for all unit tasks within a system for a given time. When multiple tasks are requested simultaneously, the task queue may adjust and manage the multiple tasks to be executed in order.

The computing device 100 assigns the plurality of tasks added to the task queue to a plurality of worker threads included in a worker thread pool, respectively to process the plurality of tasks (380).

In the present disclosure, the worker thread pool may mean software that manages the plurality of worker threads to be used in parallel. In the present disclosure, the worker thread may mean a thread assigned to process a specific task.

In one embodiment, in order to process a first-first task among a plurality of first tasks corresponding to a first schedule in a first worker thread, the computing device 100 may assign the first-first task to the first worker thread.

In one embodiment, the computing device 100 may process the first-first task by using the first worker thread. In one embodiment, the computing device 100 may process the first-first task based on a type of first-first task.

For example, when the type of first-first task is a share task shared with another worker thread, the computing device 100 may assign a first-second operator which is the destination operator among at least one first operator included in the first pipeline as a current operator which is currently processed.

The computing device 100 may attempt acquisition of a third chunk. For example, the computing device 100 may attempt acquisition of the third chunk generated in an isolate task (e.g., an isolate task performed in a previous pipeline, etc.) by using the first-second operator. The computing device 100 may perform a different operation according to whether the acquisition of the third chunk being successful. For example, the computing device 100 may execute a first-second operator when the acquisition of the third chunk is successful. As another example, the computing device 100 may increase the number of completed share tasks by a predetermined number (e.g., 1, etc.) when the acquisition of the third chunk fails. The computing device 100 may perform a return of completing a process of processing the first-first task. In one embodiment, the third chunk may be a chunk generated through the scan operator in the isolate task. For example, the third chunk may be a chunk generated through one scan operator. As another example, when the pipeline is ended with a join probe, the third chunk may be one merge chunk created by combining chunks generated through two scan operators, respectively. In one embodiment, the third chunk may be a first chunk generated by using the first-first operator which is the scan operator.

In one embodiment, a case where acquisition of the chunk fails may include a case where there is no chunk to be acquired as all chunks are acquired. That is, the case where the acquisition of the chunk fails may be a case where acquiring all chunks including the chunk is successful. Therefore, when the acquisition of all chunks is successful, the computing device 100 may increase the number of the completed share tasks (or completed isolate tasks) by a predetermined number.

As another example, when the type of first-first task is an isolate task which is not shared with another worker thread, the computing device 100 may assign the first-first operator which is the origin operator among at least one first operator included in the first pipeline as the current operator which is currently processed.

When a role type of the assigned first-first operator is the origin role type, The computing device 100 may confirm the type of first-first operator.

The computing device 100 may attempt acquisition of a second chunk when the type of first-first operator is not the scan operator. The computing device 100 may perform a different operation according to whether the acquisition of the second chunk being successful. For example, the computing device 100 may execute the first-first operator when the acquisition of the second chunk is successful. As another example, the computing device 100 may increase the number of completed isolate tasks by a predetermined number (e.g., 1, etc.) when the acquisition of the second chunk fails. In one embodiment, the second chunk may be a chunk generated through the scan operator in the isolate task. For example, the second chunk may be a chunk generated through one scan operator in the previous pipeline. As another example, when the previous pipeline is ended with the join probe, the second chunk may be one merge chunk created by combining chunks generated through two scan operators in the previous pipeline, respectively.

The computing device 100 may attempt acquisition of the tuple from a data file of the DBMS when the type of first-first operator is the scan operator. In one embodiment, the computing device 100 executes the scan operator (e.g., the scan operator generated in the first engine) to read a page from a buffer pool of the first engine by reading the data file through the second engine.

In one embodiment, the computing device 100 may increase the number of completed isolate tasks by a predetermined number (e.g., 1, etc.) when the acquisition of the tuple fails. In one embodiment, a case where acquisition of the tuple fails may include a case where there is no tuple to be acquired as all read tuples are acquired. That is, the case where the acquisition of the tuple fails may be a case where acquiring all tuples including the tuple is successful. Therefore, when the acquisition of all tuples is successful, the computing device 100 may increase the number of the completed isolate tasks by a predetermined number.

In one embodiment, when the number of completed isolate tasks corresponds to a predetermined number of total isolate tasks, the computing device 100 may schedule share tasks. The computing device 100 may assign the type of first-first task as a share task type. For example, the computing device 100 may build the first-first task to correspond to the share task type. The computing device 100 may add the built first-first task to the task queue to correspond to the share task type. The computing device 100 may perform a return of completing a process of processing the first-first task.

In one embodiment, when the number of completed isolate tasks does not correspond to the predetermined number of total isolate tasks, the computing device 100 may perform the return of completing the process of processing the first-first task.

When the acquisition of the tuple is successful, the computing device 100 may convert each column of the acquired tuple into a vector, and filters a vector necessary for processing the query to generate one first chunk. In one embodiment, the computing device 100 may vectorize data which is formed in a row-oriented format in a page, and generate it as one chunk.

In the present disclosure, the chunk may mean a set of vectors. For example, the chunk may be a set of the vectors necessary for processing the query. One chunk may include at least one vector. In one embodiment, the first chunk, the second chunk, and the third chunk may be different from each other or may correspond to each other at least partially. For example, the first chunk, the second chunk, and the third chunk may correspond to or may be the same as each other.

In one embodiment, when a vector size of one generated chunk is smaller than a predetermined vector size, the computing device 100 may repeatedly perform a step of attempting the acquisition of the tuple from the data file of the DBMS. While the step is repeatedly performed, the number of vectors included in one chunk is increased, so the vector size of one chunk may be increased. Until the vector size of one generated chunk corresponds to the predetermined vector size, the computing device 100 may repeatedly perform the step of attempting the acquisition of the tuple from the data file of the DBMS.

In one embodiment, when the vector size of one generated chunk is larger than the predetermined vector size, the computing device 100 executes the scan operator to perform at least one of compression and/or filtering for the chunk.

In one embodiment, the compression may mean performing space optimization related to a storage space by changing a method of vectorization for data. For example, the compression may mean performing the space optimization related to the storage space by changing a scheme of compressing data to one scheme of a dictionary based compression scheme, a Run-Length-Encoding (RLE) scheme, a bitmap encoding scheme, or a delta encoding scheme. In one embodiment, the dictionary based compression scheme may be a scheme that stores terms, patterns, etc., frequently used in a dictionary to reduce duplication of data and save the storage space. In one embodiment, the RLE scheme may be a scheme that compresses an interval in which the same value is continuously shown in a single column. For example, the RLE scheme may compress the interval in which the same value is continuously shown in the single column by a triplet. The triplet may be a value of an attribute, a start location in a column interval (offset), the number of elements in an interval (length). In one embodiment, the bitmap encoding scheme may be a scheme that stores a separate bitmap for each eigen value of the attribute. An offset of the vector may correspond to the tuple. For example, an i-th (e.g., i is a natural number) location of the bitmap may correspond to an i-th tuple of the table. In one embodiment, the bitmap encoding scheme may be used when expressing a binary state (e.g., male/female, existence/non-existence, true/false, etc.). For example, the bitmap encoding scheme converts the male into 1 and the female into 0, and compresses them to quickly search for the male or female. In one embodiment, the delta encoding scheme may be a scheme that records a difference between values which are shown continuously with each other in the same column. Information on the difference or a default value (e.g., a first value in a column) which is a first element of data may be stored directly in the column or stored in a separate query table.

In one embodiment, filtering may mean selecting an item which meets a necessary condition in data. The computing device 100 may add an index to a selection vector determined by performing the filtering.

After the step of assigning the first-first operator which is the origin operator among at least one first operator included in the first pipeline as the current operator, the computing device 100 may perform the first-first operator when the role type of the first-first operator is not the original role type.

After the step of assigning the first-first operator which is the origin operator among at least one first operator included in the first pipeline as the current operator, the computing device 100 may execute the first-first operator when the role type of the first-first operator is not the original role type.

When the role type of the first-first operator is the destination role type, the computing device 100 may assign the role type of the first-first operator as the origin role type. In addition, the computing device 100 may execute the first-first operator again when the type of first-first operator is not the scan operator.

When the role type of the first-first operator is not the destination role type, the computing device 100 may assign the first-second operator corresponding to a subsequent order of the first-first operator as the current operator. In addition, the computing device 100 may execute the first-second operator when the role type of the first-second operator is not the original role type or the type of first-second operator is not the scan operator.

In one embodiment, the computing device 100 executes at least one operator included in the first pipeline corresponding to the first-first task by using the first worker thread to process the first-first task.

In one embodiment, when the type of processed first-first task is shared with another worker thread, the computing device 100 may assign a new task to the first worker thread. For example, the computing device 100 may assign any one task among a plurality of first tasks corresponding to a first schedule.

In one embodiment, when the number of completed share tasks does not correspond to a predetermined number of total share tasks, the computing device 100 may assign a new task to the first worker thread. For example, the computing device 100 may assign any one task among the plurality of first tasks corresponding to the first schedule to the first worker thread.

In one embodiment, when the type of processed first-first task is the share task type shared with another worker thread, and the number of completed share tasks corresponds to the predetermined number of total share tasks, the computing device 100 may determine whether there is a second schedule different from the first schedule.

In one embodiment, when it is determined that the second schedule does not exist, the computing device 100 may assign a new task to the first worker thread. For example, the computing device 100 may assign any one task among the plurality of first tasks corresponding to the first schedule to the first worker thread.

In one embodiment, when it is determined that the second schedule exists, the computing device 100 may build a plurality of second tasks corresponding to the second schedule by using the first worker thread.

In one embodiment, the computing device 100 may add the plurality of second tasks to the task queue.

The computing device 100 may generate a first execution result including information on a result of processing a plurality of tasks (390).

In the present disclosure, the information on the result of processing the plurality of tasks may be data including a specific value, a specific table, a specific chart, etc., acquired by executing the query.

In one embodiment, the computing device 100 executes operators included in a plurality of pipelines, respectively to generate an execution result corresponding to a query. In one embodiment, the computing device 100 executes the operators included in the plurality of pipelines, respectively according to orders assigned to the plurality of pipelines, respectively to generate the execution result corresponding to the query.

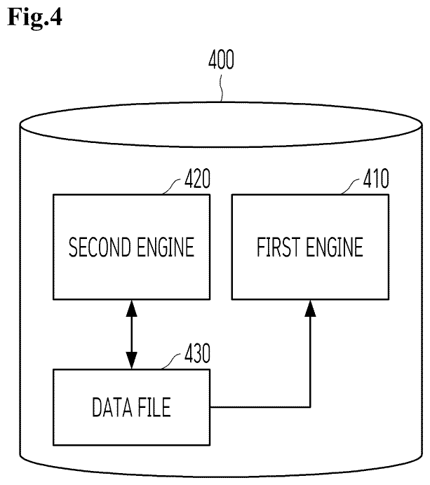

FIG. 4 exemplarily illustrates a block diagram of a DBMS according to one embodiment of the present disclosure. A detailed description of a redundant component among components illustrated in FIG. 4 may be omitted, and may be replaced with contents described above with reference to FIGS. 1 to 3.

Referring to FIG. 4, the DBMS 400 may include a first engine 410, a second engine 420, a data file 430, etc.

In one embodiment, the first engine 410 may include an OLAP based engine. In one embodiment, the first engine 410 may be a management system that may process a large amount of data in the database. The first engine 410 may use recording and aggregation data of several sources. Therefore, the first engine 410 may be specialized for processing the analytical query having a larger data size than the transactional query having a relatively small data size.

In one embodiment, the second engine 420 may include an OLTP based engine. In one embodiment, the second engine 420 may be a management system that may process the transaction in the database. The second engine 420 may use real-time and transaction data of a single source. Therefore, the second engine 420 may be specialized for processing the transactional query having a relatively smaller data size than the analytical query having a large data size.

In one embodiment, the data file 430 may be data stored in the memory 130 of the computing device 100. In one embodiment, the data file 430 may be data stored based on the OLTP. Therefore, the first engine 410 may perform only a read of the data file 430. The second engine 420 may perform a write and the read of the data file 430.

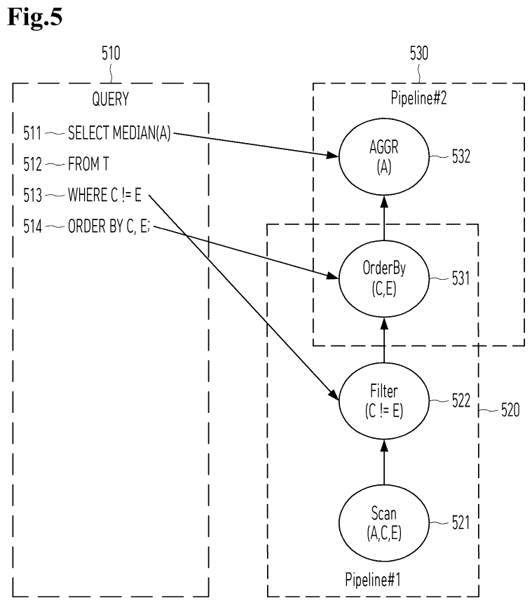

FIG. 5 exemplarily illustrates a pipeline corresponding to an input query according to one embodiment of the present disclosure. A detailed description of a redundant component among components illustrated in FIG. 5 may be omitted, and may be replaced with contents described above with reference to FIGS. 1 to 4.

Referring to FIG. 5, in one embodiment, the query 510 may include a SELECT MEDIAN(A) sentence 511, a FROM T phrase 512, a WHERE C!=E phrase 513, an ORDER BY C, E phrase 514, etc.

In one embodiment, the SELECT MEDIAN(A) sentence 511 may be used for selecting a median value of A.

In one embodiment, the FROM T phrase 512 may be used for selecting a table to be used for selecting the median value of A.

In one embodiment, the WHERE C!=E phrase 513 may be used for a value of column C and a value of column E to select different rows in the selected table.

In one embodiment, the ORDER BY C, E phrase 514 may be used for sorting a selected result based on column C and column E.

In one embodiment, a first pipeline 520 may include a scan operator 521, a filter operator 522, a sort operator 531, etc.

In one embodiment, a second pipeline 530 may include a sort operator 531, an aggregation function 532, etc.

In one embodiment, the scan operator 521 may be an operator that scans A, C, and E in the selected table.

In one embodiment, the filter operator 522 may be an operator which is configured to correspond to the WHERE C!=E phrase 513, and in which the values of column C and the value of column E select different rows in scanned data.

In one embodiment, the sort operator 531 may be an operator which is configured to correspond to the ORDER BY C, E phrase 514, and which sorts and scans the selected result based on column C and column E. The sort operator 531 may be redundantly included in the first pipeline 520 and the second pipeline 530.

As described above, the computing device 100 may build a plurality of pipelines 520 and 530 in order to process the query 510.

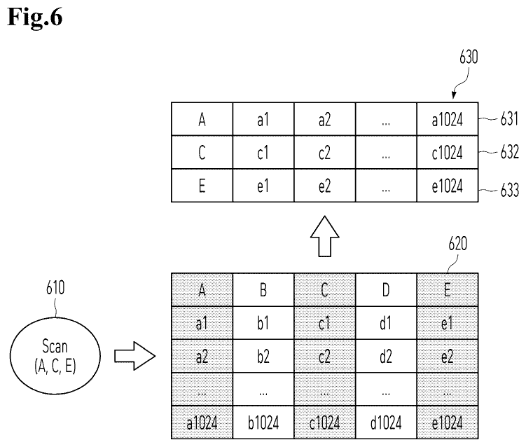

FIG. 6 exemplarily illustrates a scan according to one embodiment of the present disclosure. A detailed description of a redundant component among components illustrated in FIG. 6 may be omitted, and may be replaced with contents described above with reference to FIGS. 1 to 5.

Referring to FIG. 6, the computing device 100 may scan columns A, C, and E in a table 620 by using a scan operator 610 that scans columns A, C, and E in the table, and convert the columns into vectors for each row. For example, the computing device 100 may scan a row of column A in the table 620, and convert the scanned row into a first vector 631. The computing device 100 may scan a row of column C in the table 620, and convert the scanned row into a second vector 632. The computing device 100 may scan a row of column E in the table 620, and convert the scanned row into a third vector 633.

In one embodiment, the computing device 100 may generate one chunk 630 including the first vector 631, the second vector 632, and the third vector 633.

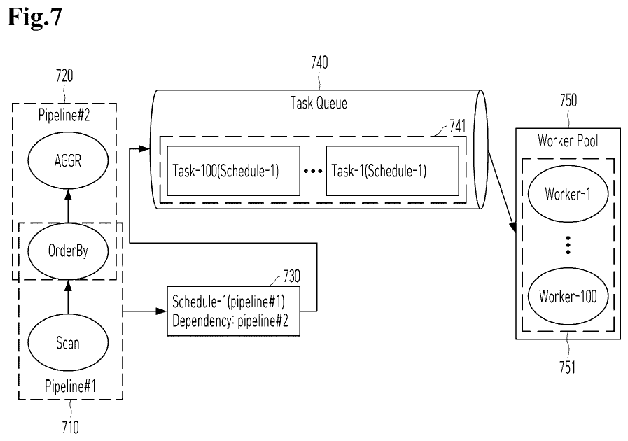

FIG. 7 exemplarily illustrates a process for processing a plurality of tasks according to one embodiment of the present disclosure. A detailed description of a redundant component among components illustrated in FIG. 7 may be omitted, and may be replaced with contents described above with reference to FIGS. 1 to 6.

In one embodiment, the computing device 100 may build at least one schedule for processing the query based on a dependency between a plurality of pipelines. For example, the computing device 100 may build a first schedule 730 for processing the query based on a dependency between a first pipeline 710 and a second pipeline 720.

In one embodiment, the computing device 100 may build a plurality of tasks 741 based on the first schedule 730.

In one embodiment, the computing device 100 may add the plurality of tasks 741 to the task queue.

In one embodiment, the computing device 100 assigns the plurality of tasks 741 added to a task queue 740 to a plurality of worker threads 751 included in a worker thread pool 750, respectively to process the plurality of tasks 741.

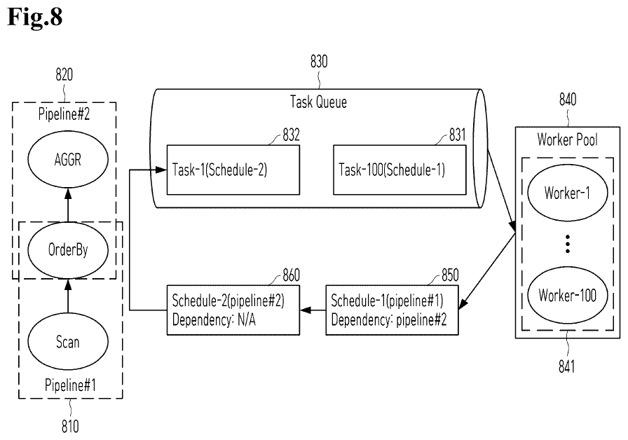

FIG. 8 exemplarily illustrates a process for processing a plurality of tasks according to another exemplary embodiment of the present disclosure. A detailed description of a redundant component among components illustrated in FIG. 8 may be omitted, and may be replaced with contents described above with reference to FIGS. 1 to 7.

Referring to FIG. 8, the computing device 100 may build at least one schedule for processing the query based on a dependency between a plurality of pipelines. For example, the computing device 100 may build a first schedule 850 and a second schedule 860 for processing the query based on a dependency between a first pipeline 810 and a second pipeline 820.

In one embodiment, the computing device 100 may add a task to a task queue 830 by considering a dependency between the first schedule 850 and the second schedule 860. For example, the computing device 100 may add a first task 832 of the second schedule 860 to the task queue 830 after a last task 831 of the first schedule 850 so that the first task 832 of the second schedule 860 is assigned to each of the plurality of worker threads 841 included in the worker thread pool 840 after the last task 831 of the first schedule 850.

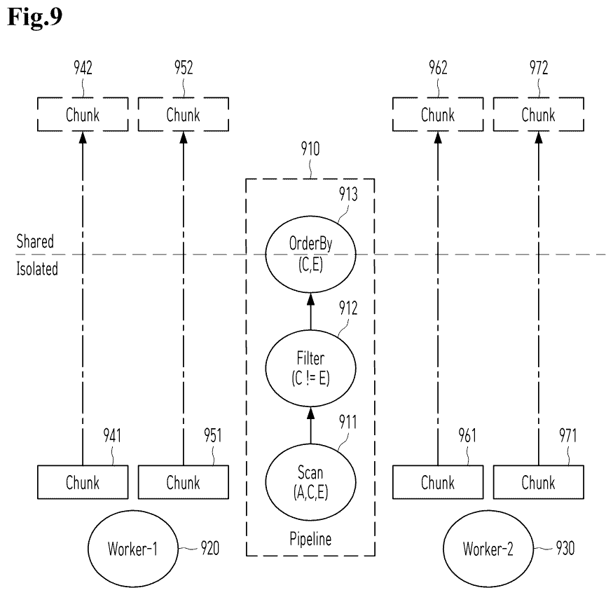

FIG. 9 exemplarily illustrates a process of executing an operator included in the pipeline according to one embodiment of the present disclosure. A detailed description of a redundant component among components illustrated in FIG. 9 may be omitted, and may be replaced with contents described above with reference to FIGS. 1 to 8.

Referring to FIG. 9, the computing device 100 may assign a first task 941 and a second task 951 where task types are isolate tasks to a first worker thread 920. The computing device 100 may assign a third task 961 and a fourth task 971 which are the isolate tasks to a second worker thread 930. Here, the tasks may be chunk units.

In one embodiment, the computing device 100 may execute operators 911, 912, and 913 included in a pipeline 910 until the isolate tasks (the first task 941, the second task 951, the third task 961, and the fourth task 971) become share tasks (a first task 942, a second task 951, a third task 962, and a fourth task 972), respectively in the plurality of worker threads 920 and 930.

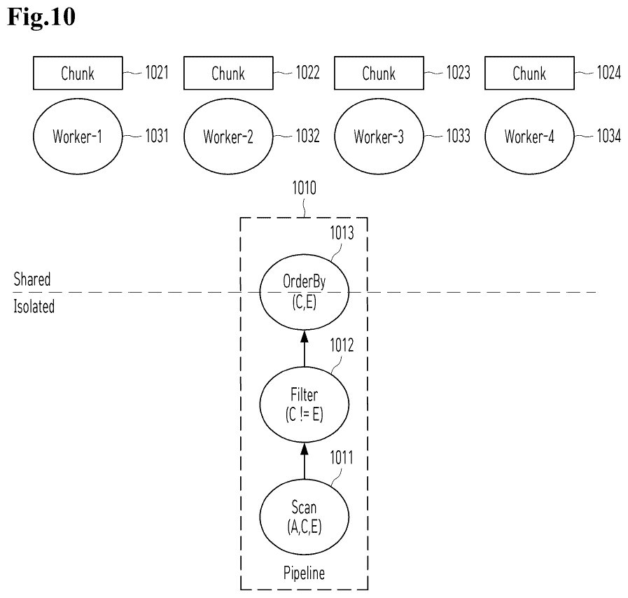

FIG. 10 exemplarily illustrates a process of executing an operator included in the pipeline according to another exemplary embodiment of the present disclosure. A detailed description of a redundant component among components illustrated in FIG. 10 may be omitted, and may be replaced with contents described above with reference to FIGS. 1 to 9.

Referring to FIG. 10, the computing device 100 executes operators 1011, 1012, and 1013 included in a pipeline 1010 until isolate tasks become share tasks, respectively in a plurality of worker threads, respectively to acquire a first task 1021, a second task 1022, a third task 1023, and a fourth task 1024 in which types of tasks are share tasks.

In one embodiment, the computing device 100 newly assigns a plurality of new worker threads 1031, 1032, 1033, and 1034, not assigning the share tasks to existing worker threads that process the isolate tasks to enhance a processing speed of a task by maximally using worker threads available according to a situation. For example, the tasks which the computing device 100 assigns to two worker threads 920 and 930 in FIG. 9 may be newly assigned to four worker threads 1031, 1032, 1033, and 1034 in a state of the share task.

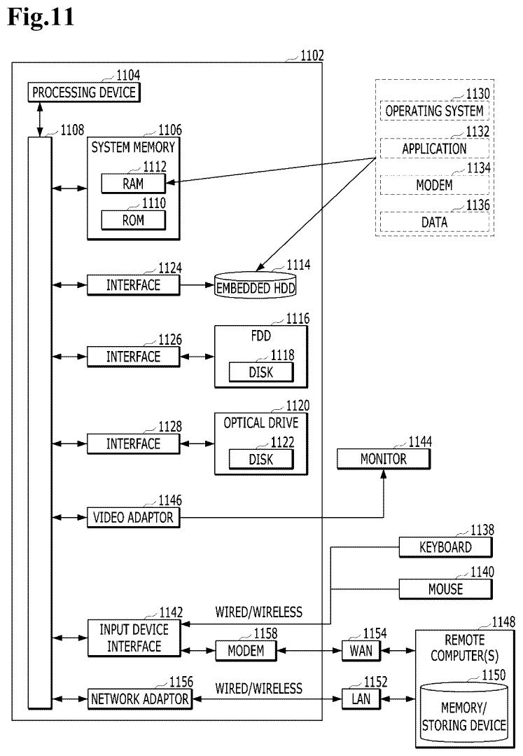

FIG. 11 is a normal schematic diagram of an exemplary computing environment in which the embodiments of the present disclosure may be implemented.

It is described above that the present disclosure may be generally implemented by the computing device, but those skilled in the art will well know that the present disclosure may be implemented in association with a computer executable command which may be executed on one or more computers and/or in combination with other program modules and/or a combination of hardware and software.

In general, the program module includes a routine, a program, a component, a data structure, and the like that execute a specific task or implement a specific abstract data type. Further, it will be well appreciated by those skilled in the art that the method of the present disclosure can be implemented by other computer system configurations including a personal computer, a handheld computing device, microprocessor-based or programmable home appliances, and others (the respective devices may operate in connection with one or more associated devices as well as a single-processor or multi-processor computer system, a mini computer, and a main frame computer.

The embodiments described in the present disclosure may also be implemented in a distributed computing environment in which predetermined tasks are performed by remote processing devices connected through a communication network. In the distributed computing environment, the program module may be positioned in both local and remote memory storage devices.

The computer generally includes various computer readable media. Media accessible by the computer may be computer readable media regardless of types thereof and the computer readable media include volatile and non-volatile media, transitory and non-transitory media, and mobile and non-mobile media. As a non-limiting example, the computer readable media may include both computer readable storage media and computer readable transmission media. The computer readable storage media include volatile and non-volatile media, transitory and non-transitory media, and mobile and non-mobile media implemented by a predetermined method or technology for storing information such as a computer readable instruction, a data structure, a program module, or other data. The computer readable storage media include a RAM, a ROM, an EEPROM, a flash memory or other memory technologies, a CD-ROM, a digital video disk (DVD) or other optical disk storage devices, a magnetic cassette, a magnetic tape, a magnetic disk storage device or other magnetic storage devices or predetermined other media which may be accessed by the computer or may be used to store desired information, but are not limited thereto.

The computer readable transmission media generally implement the computer readable command, the data structure, the program module, or other data in a carrier wave or a modulated data signal such as other transport mechanism and include all information transfer media. The term “modulated data signal” means a signal acquired by setting or changing at least one of characteristics of the signal so as to encode information in the signal. As a non-limiting example, the computer readable transmission media include wired media such as a wired network or a direct-wired connection and wireless media such as acoustic, RF, infrared and other wireless media. A combination of any media among the aforementioned media is also included in a range of the computer readable transmission media.

An exemplary environment that implements various aspects of the present disclosure including a computer 1102 is shown and the computer 1102 includes a processing device 1104, a system memory 1106, and a system bus 1108. The system bus 1108 connects system components including the system memory 1106 (not limited thereto) to the processing device 1104. The processing device 1104 may be a predetermined processor among various commercial processors. A dual processor and other multi-processor architectures may also be used as the processing device 1104.

The system bus 1108 may be any one of several types of bus structures which may be additionally interconnected to a local bus using any one of a memory bus, a peripheral device bus, and various commercial bus architectures. The system memory 1106 includes a read only memory (ROM) 1110 and a random access memory (RAM) 1112. A basic input/output system (BIOS) is stored in the non-volatile memories 1110 including the ROM, the EPROM, the EEPROM, and the like and the BIOS includes a basic routine that assists in transmitting information among components in the computer 1102 at a time such as in-starting. The RAM 1112 may also include a high-speed RAM including a static RAM for caching data, and the like.

The computer 1102 also includes an interior hard disk drive (HDD) 1114 (for example, EIDE and SATA), in which the interior hard disk drive 1114 may also be configured for an exterior purpose in an appropriate chassis (not illustrated), a magnetic floppy disk drive (FDD) 1116 (for example, for reading from or writing in a mobile diskette 1118), and an optical disk drive 1120 (for example, for reading a CD-ROM disk 1122 or reading from or writing in other high-capacity optical media such as the DVD, and the like). The hard disk drive 1114, the magnetic disk drive 1116, and the optical disk drive 1120 may be connected to the system bus 1108 by a hard disk drive interface 1124, a magnetic disk drive interface 1126, and an optical drive interface 1128, respectively. An interface 1124 for implementing an exterior drive includes at least one of a universal serial bus (USB) and an IEEE 1394 interface technology or both of them.

The drives and the computer readable media associated therewith provide non-volatile storage of the data, the data structure, the computer executable instruction, and others. In the case of the computer 1102, the drives and the media correspond to storing of predetermined data in an appropriate digital format. In the description of the computer readable media, the mobile optical media such as the HDD, the mobile magnetic disk, and the CD or the DVD are mentioned, but it will be well appreciated by those skilled in the art that other types of media readable by the computer such as a zip drive, a magnetic cassette, a flash memory card, a cartridge, and others may also be used in an exemplary operating environment and further, the predetermined media may include computer executable commands for executing the methods of the present disclosure.

Multiple program modules including an operating system 1130, one or more application programs 1132, other program module 1134, and program data 1136 may be stored in the drive and the RAM 1112. All or some of the operating system, the application, the module, and/or the data may also be cached in the RAM 1112. It will be well appreciated that the present disclosure may be implemented in operating systems which are commercially usable or a combination of the operating systems.

A user may input instructions and information in the computer 1102 through one or more wired/wireless input devices, for example, pointing devices such as a keyboard 1138 and a mouse 1140. Other input devices (not illustrated) may include a microphone, an IR remote controller, a joystick, a game pad, a stylus pen, a touch screen, and others. These and other input devices are often connected to the processing device 1104 through an input device interface 1142 connected to the system bus 1108, but may be connected by other interfaces including a parallel port, an IEEE 1394 serial port, a game port, a USB port, an IR interface, and others.

A monitor 1144 or other types of display devices are also connected to the system bus 1108 through interfaces such as a video adapter 1146, and the like. In addition to the monitor 1144, the computer generally includes other peripheral output devices (not illustrated) such as a speaker, a printer, others.

The computer 1102 may operate in a networked environment by using a logical connection to one or more remote computers including remote computer(s) 1148 through wired and/or wireless communication. The remote computer(s) 1148 may be a workstation, a computing device computer, a router, a personal computer, a portable computer, a micro-processor based entertainment apparatus, a peer device, or other general network nodes and generally includes multiple components or all of the components described with respect to the computer 1102, but only a memory storage device 1150 is illustrated for brief description. The illustrated logical connection includes a wired/wireless connection to a local area network (LAN) 1152 and/or a larger network, for example, a wide area network (WAN) 1154. The LAN and WAN networking environments are general environments in offices and companies and facilitate an enterprise-wide computer network such as Intranet, and all of them may be connected to a worldwide computer network, for example, the Internet.

When the computer 1102 is used in the LAN networking environment, the computer 1102 is connected to a local network 1152 through a wired and/or wireless communication network interface or an adapter 1156. The adapter 1156 may facilitate the wired or wireless communication to the LAN 1152 and the LAN 1152 also includes a wireless access point installed therein in order to communicate with the wireless adapter 1156. When the computer 1102 is used in the WAN networking environment, the computer 1102 may include a modem 1158 or has other means that configure communication through the WAN 1154 such as connection to a communication computing device on the WAN 1154 or connection through the Internet. The modem 1158 which may be an internal or external and wired or wireless device is connected to the system bus 1108 through the serial port interface 1142. In the networked environment, the program modules described with respect to the computer 1102 or some thereof may be stored in the remote memory/storage device 1150. It will be well known that an illustrated network connection is exemplary and other means configuring a communication link among computers may be used.

The computer 1102 performs an operation of communicating with predetermined wireless devices or entities which are disposed and operated by the wireless communication, for example, the printer, a scanner, a desktop and/or a portable computer, a portable data assistant (PDA), a communication satellite, predetermined equipment or place associated with a wireless detectable tag, and a telephone. This at least includes wireless fidelity (Wi-Fi) and Bluetooth wireless technology. Accordingly, communication may be a predefined structure like the network in the related art or just ad hoc communication between at least two devices.

The wireless fidelity (Wi-Fi) enables connection to the Internet, and the like without a wired cable. The Wi-Fi is a wireless technology such as the device, for example, a cellular phone which enables the computer to transmit and receive data indoors or outdoors, that is, anywhere in a communication range of a base station. The Wi-Fi network uses a wireless technology called IEEE 802.11(a, b, g, and others) in order to provide safe, reliable, and high-speed wireless connection. The Wi-Fi may be used to connect the computers to each other or the Internet and the wired network (using IEEE 802.3 or Ethernet). The Wi-Fi network may operate, for example, at a data rate of 11 Mbps (802.11a) or 54 Mbps (802.11b) in unlicensed 2.4 and 5GHz wireless bands or operate in a product including both bands (dual bands).

It will be appreciated by those skilled in the art that information and signals may be expressed by using various different predetermined technologies and techniques. For example, data, instructions, commands, information, signals, bits, symbols, and chips which may be referred in the above description may be expressed by voltages, currents, electromagnetic waves, magnetic fields or particles, optical fields or particles, or predetermined combinations thereof.

It may be appreciated by those skilled in the art that various exemplary logical blocks, modules, processors, means, circuits, and algorithm steps described in association with the embodiments disclosed herein may be implemented by electronic hardware, various types of programs or design codes (for easy description, herein, designated as software), or a combination of all of them. In order to clearly describe the inter compatibility of the hardware and the software, various exemplary components, blocks, modules, circuits, and steps have been generally described above in association with functions thereof. Whether the functions are implemented as the hardware or software depends on design restrictions given to a specific application and an entire system. Those skilled in the art of the present disclosure may implement functions described by various methods with respect to each specific application, but it should not be interpreted that the implementation determination departs from the scope of the present disclosure.

Various embodiments presented herein may be implemented as manufactured articles using a method, a device, or a standard programming and/or engineering technique. The term manufactured article includes a computer program, a carrier, or a medium which is accessible by a predetermined computer-readable storage device. For example, a computer-readable storage medium includes a magnetic storage device (for example, a hard disk, a floppy disk, a magnetic strip, or the like), an optical disk (for example, a CD, a DVD, or the like), a smart card, and a flash memory device (for example, an EEPROM, a card, a stick, a key drive, or the like), but is not limited thereto. Further, various storage media presented herein include one or more devices and/or other machine-readable media for storing information.

It will be appreciated that a specific order or a hierarchical structure of steps in the presented processes is one example of exemplary accesses. It will be appreciated that the specific order or the hierarchical structure of the steps in the processes within the scope of the present disclosure may be rearranged based on design priorities. Appended method claims provide elements of various steps in a sample order, but the method claims are not limited to the presented specific order or hierarchical structure.

The description of the presented embodiments is provided so that those skilled in the art of the present disclosure use or implement the present disclosure. Various modifications of the embodiments will be apparent to those skilled in the art and general principles defined herein can be applied to other embodiments without departing from the scope of the present disclosure. Therefore, the present disclosure is not limited to the embodiments presented herein, but should be interpreted within the widest range which is coherent with the principles and new features presented herein.

What is claimed is:

1. A method for processing a query performed by a computing device operable based on a Database Management System (DBMS), the method comprising:
receiving a query requesting an execution result in the DBMS;
determining a type of the query as a transactional query or an analytic query based on predetermined criteria for classifying the query; and
generating an execution result corresponding to the query by adaptively determining an engine for processing the query among a plurality of different engines or by processing the query in different ways, according to the determined type of the query.

2. The method of claim 1, wherein
the predetermined criteria includes criteria related to the number of tuples to be processed to generate a result of the query,
the transactional query is a query where the number of tuples of the query is less than a predetermined first threshold value, and
the analytic query is a query where the number of tuples of the query is equal to or greater than the predetermined first threshold value.

3. The method of claim 1, wherein
the predetermined criteria includes criteria related to a type of operator of the query,
the transactional query includes at least one of a query including Database Manipulation Language (DML), a query including Database Definition Language (DDL), a query searching for specific data, or a query where an index exists when searching for data, and
the analytic query includes a query containing at least one of an order by operator, a group by operator, a join operator, an aggregation function, or a window function.

4. The method of claim 1, wherein
the predetermined criteria includes criteria related to a processing method for transactions of the query,
the transactional query is a query used in Online Transaction Processing (OLTP), and
the analytic query is a query used in Online Analytical Processing (OLAP).

5. The method of claim 1, wherein the generating the execution result corresponding to the query comprises:
generating a first execution result corresponding to the query by processing the query using a first engine for processing the analytic query when the type of the query is determined to be the analytic query; and
generating a second execution result corresponding to the query by processing the query using a second engine for processing the transactional query when the type of the query is determined to be the transactional query.

6. The method of claim 5, wherein
the first engine includes a Query Execution Engine based on Online Analytical Processing (OLAP), and
the second engine includes a Query Execution Engine based on Online Transaction Processing (OLTP).

7. The method of claim 5, wherein generating the first execution result corresponding to the query comprises:
parsing the received query;
performing logical optimization on the parsed query to determine an order for processing requests included in the parsed query;
performing physical optimization on the logically optimized query to determine an operation method necessary for processing the requests according to the determined order;
building a plurality of pipelines and dependencies between the plurality of pipelines based on the physically optimized query—wherein a pipeline is a set of one or more operators and represents a processing unit of the query—;
building at least one schedule for processing the query based on the dependencies between the plurality of pipelines;
building a plurality of tasks based on the at least one schedule;
adding the plurality of tasks to a task queue;
processing the plurality of tasks by allocating the plurality of tasks added to the task queue to a plurality of worker threads included in a worker thread pool; and
generating the first execution result including information on the result of processing the plurality of tasks.

8. The method of claim 7, wherein the building the plurality of pipelines and the dependencies between the plurality of pipelines comprises:
building the plurality of pipelines based on an operator corresponding to a pipeline breaker,
wherein the pipeline breaker is an operator that is the start or end of each pipeline, including at least one of a sort operator, a group by operator, a join operator, an aggregation function, or a window function.

9. The method of claim 7, wherein the building the plurality of pipelines and the dependencies between the plurality of pipelines comprises:
determining a type of each of a plurality of operators included in each of the plurality of pipelines as one of an Origin role type, an On-The-Fly role type, or a Destination role type,
wherein the Origin role type is a role of a start operator of a pipeline, generating, loading, or pre-processing a chunk,
the On-The-Fly role type receives one chunk and processes it in memory, and
the Destination role type processes the chunk to generate an output chunk.

10. The method of claim 7, wherein the processing the plurality of tasks comprises:
allocating a first-first task to a first worker thread to process the first-first task among a plurality of first tasks corresponding to a first schedule in the first worker thread; and
processing the first-first task using the first worker thread.

11. The method of claim 10, wherein the processing the first-first task using the first worker thread comprises:
processing the first-first task by executing at least one operator included in a first pipeline corresponding to the first-first task using the first worker thread;
determining whether a second schedule different from the first schedule exists if a type of the processed first-first task is a share task type shared with other worker threads, and the number of completed share tasks corresponds to a predetermined number of total share tasks;
building a plurality of second tasks corresponding to the second schedule using the first worker thread if it is determined that the second schedule exists; and
adding the plurality of second tasks to the task queue.

12. The method of claim 11, wherein the processing the first-first task by executing at least one operator included in a first pipeline corresponding to the first-first task using the first worker thread comprises:
assigning a first-first operator, which is an origin operator among at least one first operator included in the first pipeline, as a current operator being processed if a type of the first-first task is an isolate task not shared with other worker threads;
confirming a type of the first-first operator if a role type of the first-first operator is an origin role type;
attempting to acquire a tuple from a data file of the DBMS if the type of the first-first operator is a scan operator;
converting the acquired tuple into vectors for each column and selecting vectors necessary for processing the query to generate a first chunk if the acquisition of the tuple is successful;
increasing the number of completed isolate tasks by a predetermined number if the acquisition of the tuple fails; and
scheduling a share task if the number of completed isolate tasks corresponds to a predetermined number of total isolate tasks.

13. The method of claim 12, further comprising:
attempting to acquire a second chunk if the type of the first-first operator is not a scan operator after confirming the type of the first-first operator;
executing the first-first operator if the acquisition of the second chunk is successful; and
increasing the number of completed isolate tasks by the predetermined number if the acquisition of the second chunk fails.

14. The method of claim 11, wherein processing the first-first task by executing at least one operator included in a first pipeline corresponding to the first-first task using the first worker thread comprises:
assigning a first-second operator, which is a destination operator among at least one first operator included in the first pipeline, as a current operator being processed if a type of the first-first task is a shared task;
attempting to acquire a third chunk generated in an isolate task;
executing the first-second operator if the acquisition of the third chunk is successful; and
increasing the number of completed share tasks by a predetermined number if the acquisition of the third chunk fails.

15. A computer program stored in a non-transitory computer-readable medium, wherein the computer program causes a processor of a computing device operable based on a Database Management System (DBMS) to perform a method for processing a query, the method comprising:
receiving a query requesting an execution result in the DBMS;
determining a type of the query as a transactional query or an analytic query based on predetermined criteria; and
generating an execution result corresponding to the query by adaptively determining an engine for processing the query among a plurality of different engines or by processing the query in different ways, according to the determined type of the query.

16. A computing device operable based on a Database Management System (DBMS), comprising:
a processor;
a memory; and
a network unit,
wherein the processor is configured to:
receive a query requesting an execution result in the DBMS;
determine a type of the query as a transactional query or an analytic query based on predetermined criteria; and
generate an execution result corresponding to the query by adaptively determining an engine for processing the query among a plurality of different engines or by processing the query in different ways, according to the determined type of the query.
